(19) United States
(12) Patent Application Publication
(10) Pub. No.: US 2003/0034483 A1
(43) Pub. Date: Feb. 20, 2003

(54) Portable castor mounted floor jack engageable with a frame rail for lifting a vehicle

(76) Inventor: Floyd Anderson, Detroit, MI (US)

Correspondence Address: Douglas J. McEvoy, Gifford, Krass, Groh, Sprinkle,, Anderson & Citkowski, P.C., 280 North Old Woodward, Suite 400, Birmingham, MI, 48009, US

(21) Appl. No.: 09/933,523

(22) Filed: Aug. 20, 2001

(51) Int. Cl. B66F 3/00

(52) U.S. Cl. 254/7 B

(57) ABSTRACT

A portable and transportable floor jack for use in lifting a vehicle, the vehicle including underside extending frame rails associated with first and second sides of the vehicle. The floor jack includes a substantially plate-shaped member having a specified length, width and thickness and is typically provided with a generally square shaped configuration. A hydraulically powered cylinder assembly is contained within a housing secured to and extending upwardly from an upper face of the plate-shaped member. The cylinder assembly includes a vertically actuable shaft terminating in an upwardly facing cradle portion adapted for engaging a selected underside location of one of the vehicle frame rails. A plurality of castors are mounted at selected corner locations of a lower face of the plate shaped member, the castors permitting multi-axial and transportable motion of the floor jack across a floor support surface.

### BACKGROUND OF THE INVENTION

1. Field of the Invention

The present invention relates generally to portable floor jacks and elevating assemblies. More particularly, the present invention discloses a portable castor mounted floor jack which is easily transportable and storable and which may be utilized to elevate a portion or all of a vehicle, in particular by virtue of its particular configuration for engaging the vehicle's frame rail.

2. Description of the Prior Art

The prior art is well documented with varying types of portable jacking and lifting devices. The purpose behind such devices is to most effectively and conveniently lift heavy objects, such as automobiles and other types of land supported vehicles and it has been particularly found that jacking assemblies mounted on wheels provide a degree of ease in transportability and positionability over other non-wheel supported lifting devices.

U.S. Pat. No. 4,596,378, issued to Liang et al., discloses a hydraulic four-wheel jack and including a piston and cylinder in which the piston extends in an upwardly direction and bears against a cross-wise shaft pivotably mounted between parallel cantilever arms. The jack further incorporates a base having a unique series on interior passages provided with one-way spring loaded ball check valves, whereby fluid communication is provided for the hydraulics of the jack.

U.S. Pat. No. 5,156,375, issued to Liegel et al., discloses a load carrying adaptor for a transmission jack having an adjustable platform located on the upper end of the jack, the adaptor in turn including a centering block mounted on the platform. An inner and an outer plate assembly is mounted on the platform on each side of the centering block and are simultaneously movable toward and away from the centering block. A fixture support bar is mounted on each of the plate assemblies and a pair of fixture assemblies are movably mounted on each of the support bars. The fixture assemblies are separately movable to support and align the longitudinal axis of a transmission on the platform and the inner and outer plate assemblies are longitudinally movable to increase or decrease the distance between the fixture assemblies to accommodate the different length transmissions.

U.S. Pat. No. 4,804,162, issued to Rice, teaches an adjustable engine support device for use, in particular, with front wheel drive vehicles. An adjustable base is fitted with a plurality of legs which adjust to varying height. The legs in turn include, on their, rotatable cradles sized to receive an engine mount. The engine support is first wheeled underneath a previously elevated vehicle and the vehicle's engine and its mount are then lowered onto the cradles and the support is then wheeled away from the vehicle.

Finally, U.S. Pat. No. 4,364,148, issued to McVicker, teaches a combination dual wheel castor and jack assembly having a support structure with a nut-like portion and elongated portions attached thereto. The elongated portions extend in opposite directions from the nut-like portion and a support structure includes a hole passing through at least one of the elongated portions in opposite directions. The hole is internally threaded along at least a portion of its length and a jack means including an elongated and threaded shaft portion and foot portion are rotatably mounted at one end of the shaft portion and adapted to be threaded in the hole formed in the support structure. A castor portion further includes a pair of wheels spaced apart and attached to a swivel frame by an axle. The swivel frame is in turn rotatably mounted to the support structure.

### SUMMARY OF THE PRESENT INVENTION

The present invention is a portable castor mounted floor jack which is easily transportable and storable and which may be utilized to elevate a portion or all of a vehicle, in particular by virtue of its particular configuration for engaging the vehicle's frame rail. The vehicle to be lifted typically includes a pair of such underside rails extending along both the first and second sides of the vehicle.

The jack includes a substantially plate-shaped member having a specified length, width and thickness and which is typically provided in a square shaped configuration. A hydraulic cylinder housing is secured in upwardly extending fashion from an upper face of the plate-shaped member and includes a vertically actuable shaft terminating in an upwardly facing cradle portion having a substantially “U” shaped configuration for engaging a selected vehicle frame rail. An alternate variant contemplator the use of an attachment rail cradle with a downwardly extending sleeve portion and which affixes over a conventional shaft portion of a hydraulic jack.

An actuating mechanism may also be provided, in fluidic communication with the cylinder, and for receiving an inserting handle for elevating or lowering the cylinder. Alternatively, a variation of the cylinder assembly contemplates the placement of exterior threads on the shaft and permitting the shaft to, in combination, rotate and vertically actuate in either of first or second directions. A slip coupling interconnects an upper end of the threaded shaft and the upwardly facing cradle portion and permits the shaft to rotate relative the cradle portion.

A plurality of castors, typically four, are provided at selected corner locations of the plate-shaped member and provide heavy duty support to the assembly as it is wheeled in multi-axial fashion underneath the vehicle and during elevation of the selected location of the vehicle. The castors further include locking mechanisms for fixedly securing the floor jack at a desired location and once it has been positioned.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the portable floor jack according to a first preferred embodiment of the present invention;

FIG. 2 is an environmental view illustrating a plurality of floor jacks employed in lifting a vehicle;

FIG. 3 is a sectional cutaway of the substantially “U” shaped cradle lifting portion forming a part of the jack assembly according to the present invention;

FIG. 4 is a view of the portable floor jack according to a further preferred embodiment of the present invention;

FIG. 5 is a view of the portable floor jack according to a yet further preferred embodiment of the present invention;

FIG. 6 is a rotated and top plan view of the base plate forming a portion of the floor jack illustrated in the embodiment of FIG. 5;

FIG. 7 is a sectional view of an attachment rail cradle forming a part of the castor mounted floor jack according to a further preferred variant; and

FIG. 8 illustrates the rail cradle supported on the shaft portion of the jack.

### DETAILED DESCRIPTION OF THE PREFERRED EMBODIMENTS

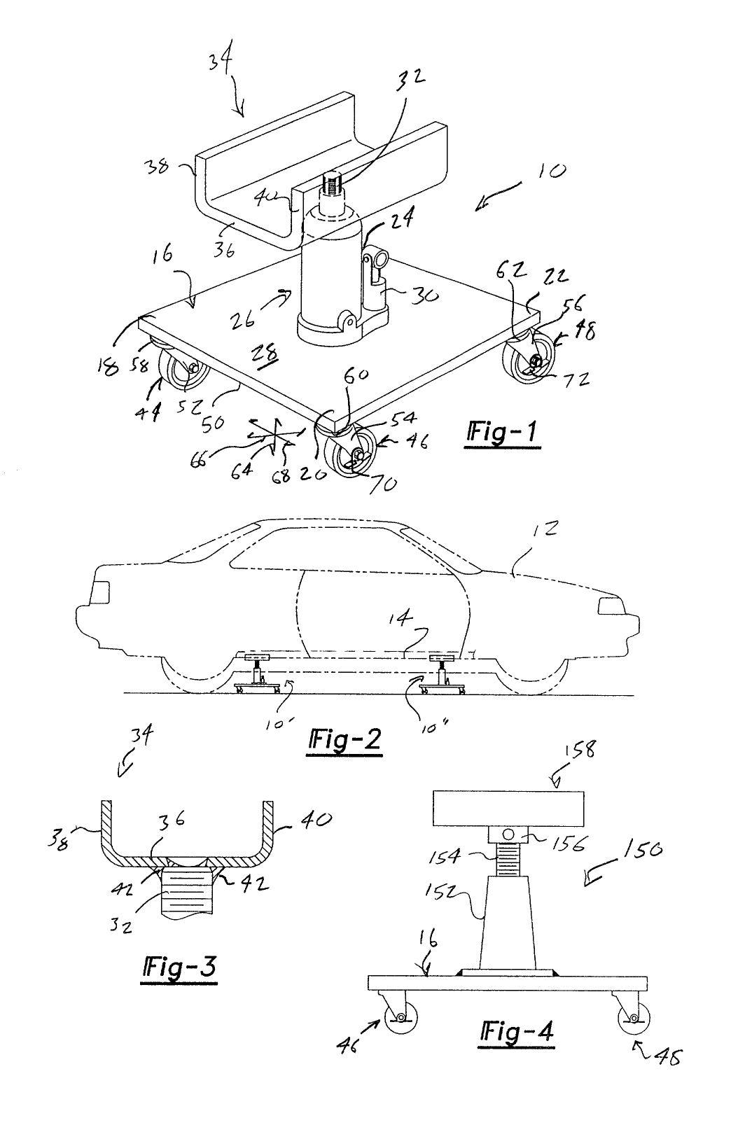

Referring now to FIG. 1, a portable floor jack assembly is illustrated at 10 according to a first preferred embodiment of the present invention and for use, either singularly or in plural as illustrated at 10′ and 10″ in FIG. 2, for lifting a vehicle 12 and in particular for engaging an underside extending frame rail 14 associated with either or both sides of the vehicle 12. As previously stated, the portable castor mounted floor jack is easily transportable and storable and which may be utilized to elevate a portion or all of a vehicle, in particular by virtue of its particular configuration for engaging the vehicle's frame rail.

Referring again to FIG. 1, a substantially plate-shaped member 16 is provided and typically is configured with a square shape with first, second, third and fourth extending edges defining first 18, second 20, third 22, and fourth 24 corner locations. The plate-shaped member 16 may be constructed of any heavy-duty material, such as a grade steel, but is preferably of an aluminum construction which provides the combined aspects of durability, strength and light weight.

A housing 26 is secured to and extends upwardly from an upper face 28 of the plate-shaped member 16. The housing 26 typically encloses a conventional and hydraulic cylinder assembly as is known in the art. It is also envisioned that cylinder housing assemblies, of varying sizes, can be interchanged with the plate-shaped member 16 and so as to modify the lifting capacity of the jack and such as by rating each interchangeable unit with a given tonnage lifting capacity. The hydraulic cylinder further includes an actuating portion 30 in operative and fluidic communication with the housing 26 of the cylinder, as well as a vertically actuable shaft 32 extending upwardly from the housing 26 and terminating in a substantially “U” shaped and upwardly facing cradle portion 34.

Referring also to the enlarged sectional view of FIG. 2, the substantially “U” shape of the cradle portion 34 is further defined by a base surface 36 which interconnects first 38 and second 40 upwardly extending sides and for abuttingly engaging an underside location of a selected vehicle frame rail 14. Additionally, the cradle 34 may by secured in any heavy-duty fashion to the upper end of the shaft 32 and such as through the application of welds 42. The arrangement of the cradle 34 further permits it to engage the vehicle underside in a manner which minimizes the likelihood of damage to gas lines, brake lines and the like and by virtue of the extending sides 38 and 40 engaging at locations outside of the frame while the base surface 36 squarely abuts an underneath location of the rails. Further, the sides 38 and 40 may be of an equal height, as illustrated, or may be of different heights given the desired application.

A plurality of four castor assemblies (best illustrated at 44, 46 and 48 with the fourth castor assembly hidden from view in FIG. 1) are provided at locations proximate to the first 18, second 20, third 22 and fourth 24 corners of the plate-shaped member 16 and such they extend from a corresponding lower face 50 of the plate-shaped member 16. The castors each include swivel portions, see at 52, 54 and 56 for illustrated castors 44, 46 and 48, respectively. Additionally, each castor further includes a mounting portion, see at 58, 60 and 62 respectively again for castors 44, 46 and 48, and which is in turn welded or otherwise secured to the underside 50 of the plate-shaped member 16 while permitting the individual castors to freely rotate in heavy-duty supported fashion.

In this fashion, the floor jack assembly 10 is permitted to be transported in simultaneous and multi-directional fashion and as illustrated representatively by axial direction indicators 64, 66 and 68. An additional feature provided by the castors are locking mechanisms (see at 70 and 72 for castors 46 and 48, respectively). The locking mechanisms provide for the fixed and immovable location of the floor jack 10 once it has been transported to the desired location and in which the cradle 34 is arrayed in position underneath the selected vehicle rail 14 and prior to the actuating of the hydraulic cylinder.

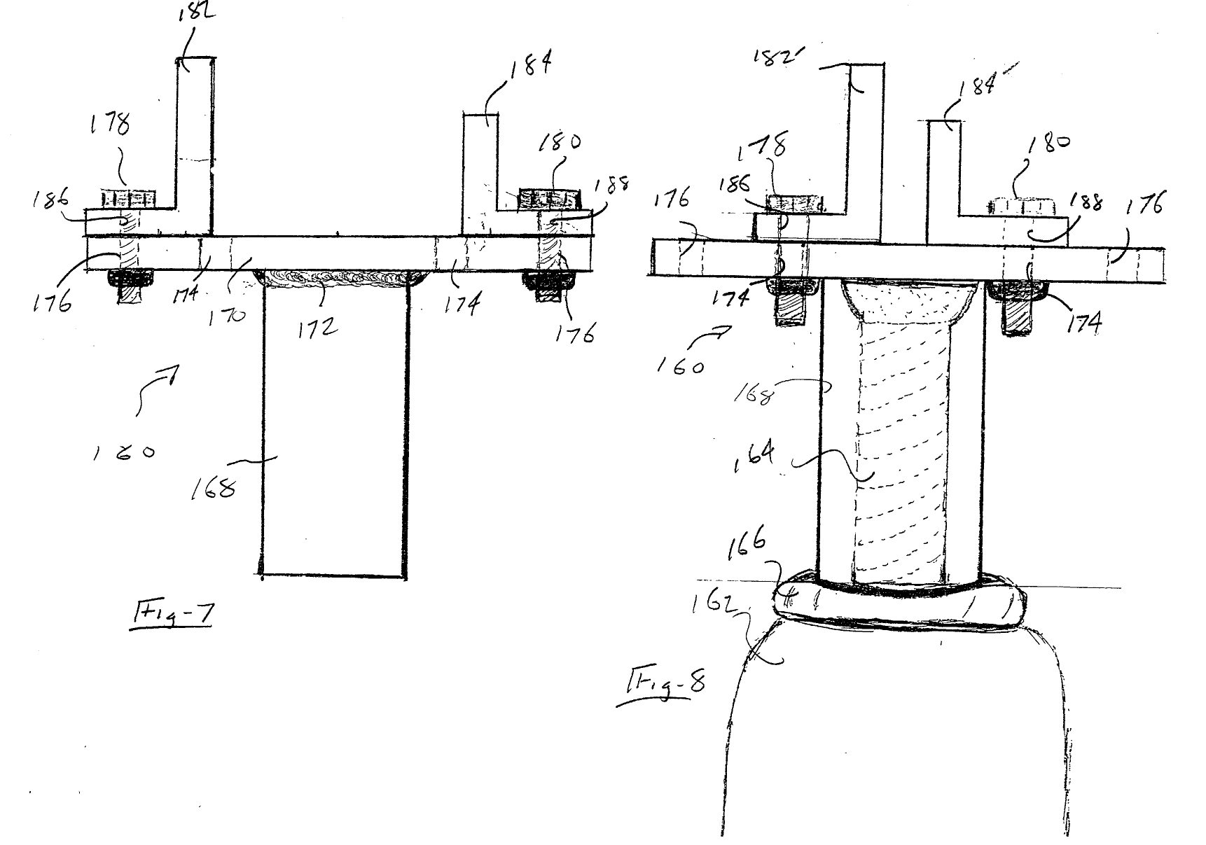

Referring to FIGS. 5 and 6, a variation of the floor jack assembly of the present invention is illustrated at 74. The floor jack assembly is similar to that previously represented in FIG. 1, with the exception that plate-shaped member 76 is provided with apertures 78 and 80, corresponding to the placement of hydraulic cylinder assembly 82 and actuating portion 84. Additional apertures 86, 88, 90 and 92 extend through the plate-shaped member 76 at corresponding corner locations 94, 96, 98 and 100. The apertures 86, 88, 90 and 92 correspond to the placement of castor assemblies (illustrated in the side view of FIG. 5 by castor assemblies 102 and 104 corresponding to apertures 88 and 90 in FIG. 6).

Fasteners are provided, in lieu of welding, for securing the cylinder housing 82 upon the plate-shaped member 76. Referring again to the side view of FIG. 5, a larger sized bolt fastener 106 extends from an underside face of the plate member 76, through the substantially centrally defined aperture 78 and sandwiching a washer 108 therebetween, and engaging an underside and interior location 110 of the cylinder housing 82. Likewise, a similar type fastener 112 is employed for engaging the actuating portion 84 and yet additional fasteners (see at 114 and 116 for apertures 88 and 90 and associated castors 102 and 104) insert downwardly from the upper face of the plate-shaped member for engaging and securing the castors in place.

While not illustrated in this embodiment, it is again understood that locking mechanisms (such as at 70 and 72 in FIG. 1) may again be employed for securing the floor jack 74 in place. Additionally, a vertically actuable shaft 118 extends upwardly from the hydraulic cylinder housing 82 and terminates in substantially “U” shaped and upwardly facing cradle portion 120.

Referring still to FIG. 5, an elongated handle 122 is generally illustrated for engagement with the actuating portion 84, in turn hydraulically/fluidically communicated with the cylinder housing 82. The elongated handle 122 further includes a first elongated portion 124 (in turn having a first inserting end 126 adaptable for engaging the actuating portion 84 and a second opposite end 128); the handle 122 further including a second elongated and internally hollowed portion 130 (again with first 132 and second 134 ends) for axially and telescopically receiving the second and inserting end 128 of the first elongated portion 124.

A plurality of spaced apart apertures (see at 136) are defined at specified axial locations along the first elongated portion 124 of the handle 122, a further aperture 138 being defined in the second elongated portion 130 and, upon aligning with a selected one of the first plurality of spaced apart apertures 136, receives an inserting pin 140 to define a fixed and overall length of the handle 122. An additional feature of the handle 122 is the provision of a welded screw bolt and pin arrangement, see at 142 and 144 extending from a first end 126 and at 142′ and 144′ extending from second opposite end 134. The bolt and pin arrangements are configured for receivingly engaging the handle within a collar portion 146 (in a fashion indicated by directional arrow 150) associated with the actuating portion 84 and to operatively engage said elevating assembly once it has been transported under the vehicle 12.

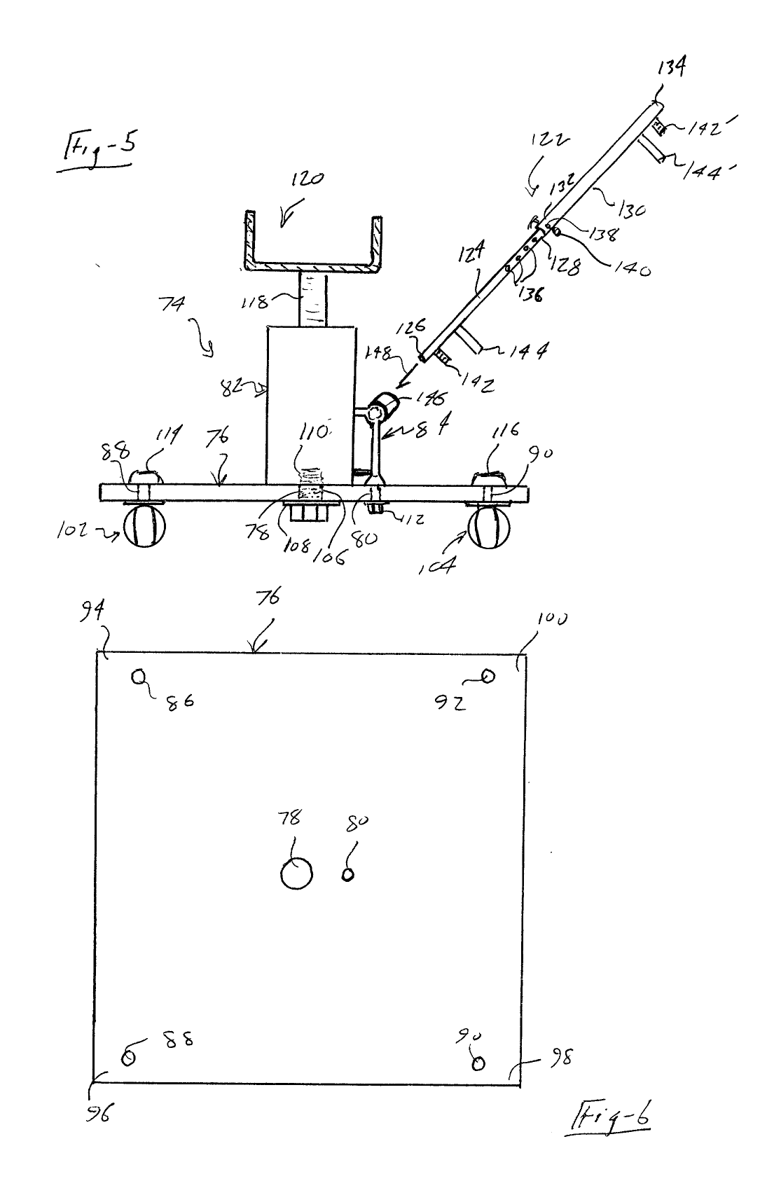

Referring to FIG. 4, a further variation of the floor jack is illustrated at 150, substantially as previously described and again illustrated in side view the plate-shaped member 16 and castor assemblies 46 and 48. The floor jack 150 differs from the previous variants in the construction of cylinder housing 152 to incorporate a vertically actuable shaft 154 having exterior threads placed thereon for permitting the shaft 154, upon being engaged by the hydraulic elevating assembly, to in combination rotate and vertically actuate in either of first and second directions. A slip coupling 156 interconnects an upper end of said threaded shaft 154 and upwardly facing cradle portion 158 and permits the shaft to rotate relative to the cradle portion. Although not shown, it is further contemplated that the cylinder housing 152 may be actuated in a fashion similar to that provided in the embodiments of FIGS. 1 and 5. Alternatively, a switch assembly or the like (not shown) can be configured into the housing 152 according to the abilities of one skilled in the art and to create the necessary rotatable motion of the threaded screw/shaft 154 in both the elevating and lowering direction relative the elevated housing 152.

Referring finally to FIGS. 7 and 8, an attachment rail cradle portion is illustrated generally at 160 according to a yet further preferred variant of the invention. The cradle portion 160 is specifically designed to fit over an existing hydraulic jack portion 162 having an upwardly shaft 164 connected to the main body of the jack by a slip coupling 166 or other suitable bearing structure.

The cradle portion 160 includes such features as an internally hollowed and reinforced sleeve 168 and which is secured to and extends generally downwardly from a generally flat top plate 170. In the example illustrated, welds 172 may be used to secure the downwardly extending sleeve 168 in reinforcing fashion, however it is also contemplated that the sleeve 168 and plate 170 may be integrally formed, such as through an appropriate casting manufacture process, within the scope of the invention.

As with the earlier described embodiments, structure is provided for establishing a substantially “U” shaped configuration for gripping the underside extending frame rails of the vehicle. The plate 170 includes first inwardly spaced 174 and second outwardly spaced 176 pairs of apertures, each pair of which are formed in vertical fashion through the plate and at generally opposite ends thereof. Bolt and nut fasteners, see at 178 and 180, are secured, respectively, in either the outer 176 or inner spaced 174 pairs of apertures (in laterally adjustable fashion) and thereby to affix the upwardly extending engagement portions 182 and 184 from the surface of the plate 170.

As are also illustrated, the engagement portions 182 and 184 are typically formed as substantially “L” shaped portions, each with an upwardly extending leg and a substantially right angle extending leg which is mounted flush with the top surface of the plate 170 and through which additional apertures, see at 186 and 188, are provided which align with either the inner 174 or outer 176 pair formed through the plate 170. It is also evident that the upwardly extending legs of the engagement portions 182 and 184 may be constructed to varying heights within the scope of the invention.

The illustration of FIG. 7 further shows the engagement portions 182 and 184 in a first outwardly spaced arrangement whereas the environmental view of FIG. 8 illustrates them in a second inwardly spaced manner 182′ and 184′, such as to accommodate a narrower rail portion (not shown) of a vehicle to be lifted. Additionally, it is contemplated that the upwardly extending engagement portions can be adjusted between the positions indicated while the vehicle is lifted and its associated frame rail supported on the plate 170.

Referring finally again to FIG. 8, the upwardly extending shaft portion 164 is illustrated in phantom and to illustrate the snug fit established with the slidably engaged sleeve 168 of the cradle portion. This dimensioning arrangement of the sleeve 168 prevents the cradle portion 160 from accidentally disengaging from the hydraulic jack 162 during lifting.

It is evident therefore that the present invention discloses a novel portable and transportable jack for more easily permitting a user to position the jack underneath a vehicle to be lifted, in combination with the ability to securely lock the floor jack and place prior to abutting engagement with and around the extending frame rails of the vehicle. Having described my invention, additional preferred embodiments will become apparent to those skilled in the art to which it pertains without deviating from the scope of the appended claims.

I claim:

1. A portable and transportable floor jack for use in lifting a vehicle, the vehicle including underside extending frame rails associated with first and second sides of the vehicle, said floor jack comprising:
a substantially plate-shaped member having a specified length, width and thickness;
a housing secured to and extending upwardly from an upper face of said plate-shaped member, said housing enclosing an elevating assembly which further comprises a vertically actuable shaft terminating in an upwardly facing cradle portion; and
a plurality of castors mounted at selected locations of a lower face of said plate shaped member, said castors permitting multi-axial and transportable motion of said floor jack across a floor support surface.

2. The portable and transportable floor jack as described in claim 1, said elevating assembly further comprising a hydraulic cylinder.

3. The portable and transportable floor jack as described in claim 2, further comprising an actuating portion in operative and fluidic communication with said hydraulic cylinder, said actuating portion receiving an inserting end of an elongated handle.

4. The portable and transportable floor jack as described in claim 3, said elongated handle further comprising a first elongated portion and a second elongated and internally hollowed portion for axially and telescopically receiving said first elongated portion.

5. The portable and transportable floor jack as described in claim 4, further comprising a plurality of spaced apart apertures defined at specified axial locations along said first elongated portion, a further aperture defined in said second elongated portion and, upon aligning with a selected one of said plurality of spaced apart apertures, receiving an inserting pin to define an overall length of said handle.

6. The portable and transportable floor jack as described in claim 5, said handle further comprising a welded screw bolt and pin arrangement extending from at least one of first and second opposite ends, said bolt and pin receivingly engaging said actuating portion to operatively engage said elevating assembly.

7. The portable and transportable floor jack as described in claim 1, each of said plurality of castors further comprising a locking mechanism.

8. The portable and transportable floor jack as described in claim 1, said vertically actuable shaft further comprising exterior threads placed thereon for permitting said shaft, upon being engaged by said elevating assembly, to in combination rotate and vertically actuate in either of first and second directions, a slip coupling interconnecting an upper end of said threaded shaft and said upwardly facing cradle portion and permitting said shaft to rotate relative to said cradle portion.

9. The portable and transportable floor jack as described in claim 1, said plate-shaped member further comprising a square shaped configuration and mounting a plurality of four castors at selected first, second, third and fourth corner locations thereof.

10. The portable and transportable floor jack as described in claim 1, said upwardly facing cradle portion further comprising a substantially “U” shape in configuration and which is adapted to receive a selected one of the underside extending frame rails associated with the vehicle.

11. The portable and transportable floor jack as described in claim 1, said plate-shaped member further comprising a square shaped configuration and being constructed of an aluminum material.

12. The portable and transportable floor jack as described in claim 1, further comprising a plurality of apertures defined in said plate-shaped member and corresponding with said placement of said housing and said castors.

13. The portable and transportable jack as described in claim 12, further comprising a plurality of bolt fasteners and nuts for securing said housing and said castors to said plate-shaped member.

14. The portable and transportable jack as described in claim 11, further comprising said housing and said castors being welded to said plate-shaped member.

15. The portable and transportable jack as described in claim 2, said hydraulic cylinder housing further comprising an interchangeable unit rated with a specified lifting capacity.

16. The portable and transportable jack as described in claim 1, further comprising a plurality of floor jacks adapted to be positioned at varied underside locations of said vehicle, each of said upwardly facing cradle portions further comprising a substantially “U” shape in configuration for engaging the underside extending frame rails.

17. The portable and transportable jack as described in claim 1, said cradle portion further comprising a top plate and a downwardly extending sleeve, said sleeve slidably engaging over an upwardly extending cylinder portion of said jack.

18. The portable and transportable jack as described in claim 17, further comprising first and second upwardly extending portions which are secured to said top plate in laterally adjustable fashion, said upwardly extending portions defining, in combination, a substantially “U” shape configuration for receiving one of the underside frame rails of the vehicle.

19. A portable and transportable floor jack for use in lifting a vehicle, the vehicle including underside extending frame rails associated with first and second sides of the vehicle, said floor jack comprising:
a substantially plate-shaped member having a specified length, width and thickness;
a housing secured to and extending upwardly from an upper face of said plate-shaped member, said housing enclosing a hydraulic cylinder assembly which further comprises a vertically actuable shaft terminating in an upwardly facing and substantially “U” shaped cradle portion adapted for engaging a selected one of the underside extending vehicle frame rails; and
a plurality of castors mounted at selected corner locations of a lower face of said plate shaped member, said castors permitting multi-axial and transportable motion of said floor jack across a floor support surface, each of said castors further comprising locking mechanisms.

20. A portable and transportable floor jack for use in lifting a vehicle, the vehicle including underside extending frame rails associated with first and second sides of the vehicle, said floor jack comprising:
a substantially plate-shaped member having a specified length, width and thickness;
a housing secured to and extending upwardly from an upper face of said plate-shaped member, said housing enclosing a hydraulic cylinder assembly which further comprises a vertically actuable shaft terminating in an upwardly facing and substantially “U” shaped cradle portion adapted for engaging a selected one of the underside extending vehicle frame rails;
said shaft including exterior threads placed thereon for permitting said shaft, upon being engaged by said cylinder assembly, to in combination rotate and vertically actuate in either of first and second directions, a slip coupling interconnecting an upper end of said threaded shaft and said upwardly facing cradle portion and permitting said shaft to rotate relative to said cradle portion; and
a plurality of castors mounted at selected locations of a lower face of said plate shaped member, said castors permitting multi-axial and transportable motion of said floor jack across a floor support surface.
